(19) United States
(12) Patent Application Publication
(10) Pub. No.: US 2010/0188764 A1
(43) Pub. Date: Jul. 29, 2010

(54) ADJUSTABLE REAR VIEW MIRROR

(75) Inventor: Pin-Hsing Wu, Chang-Hua Hsien (TW)

Correspondence Address: OSHA LIANG L.L.P., TWO HOUSTON CENTER, 909 FANNIN, SUITE 3500, HOUSTON, TX, 77010, US

(73) Assignee: KEN SEAN FACTORY CO., LTD., Chang-Hua Hsien (TW)

(21) Appl. No.: 12/576,673

(22) Filed: Oct. 9, 2009

(30) Foreign Application Priority Data
Jan. 23, 2009 (CN) 200920003810.7

(51) Int. Cl. G02B 7/198

(52) U.S. Cl. 359/872

(57) ABSTRACT

An adjustable rearview mirror includes a mounting seat, and a connecting unit including a rotating seat. The rotating seat has a main body pivotally connected to the mounting seat, and a supporting wall unit extending from the main body. The rotating seat is changeable between a rotatable state and a non-rotatable state. A supporting rod has a pivot end pivotally connected to the supporting wall unit, and a supporting end opposite to the pivot end. The supporting rod is changeable between an adjustable state and a non-adjustable state. A rear view mirror body is connected to the supporting rod end.

### CROSS-REFERENCE TO RELATED APPLICATION

This application claims priority of Chinese Application No. 200920003810.7, filed on Jan. 23, 2009.

### BACKGROUND OF THE INVENTION

1. Field of the Invention

The invention relates to a rear view mirror, more particularly to an adjustable rear view mirror.

2. Description of the Related Art

Referring to FIGS. 1 and 2, in Taiwanese Patent Publication No. 484560, a rear view mirror 5 for a motorcycle comprises a mirror body 51, an internally threaded fastening member 52, a spring washer 53, and a positioning post 54. The rear view mirror body 51 includes a mirror surface 511, a slanted supporting rod 512, and a supporting rod 513 extending from the slanted supporting rod 512 and having an externally threaded lower end portion. The supporting rod 513 extends through the fastening member 52 and the spring washer 53 to engage an internally threaded portion of the positioning post 54. When an external force is applied to strike the rear view mirror 5, the mirror body 51 can rotate about the supporting rod 513, thus preventing the mirror body 51 from damage. However, the position of the mirror surface 511 cannot be adjusted to fit completely users' requirement, thereby resulting in a relatively low flexibility during use.

### SUMMARY OF THE INVENTION

Therefore, the object of the present invention is to provide an adjustable rear view mirror capable of alleviating the above drawbacks of the prior art.

Accordingly, an adjustable rear view mirror of the present invention comprises a mounting seat, and a connecting unit including a rotating seat. The rotating seat has a main body pivotally connected to the mounting seat, and a supporting wall unit extending from the main body along a first axis. The rotating seat is changeable between a rotatable state, where the main body is rotatable relative to the mounting seat about the first axis, and a non-rotatable state, where the main body is fixed on the mounting seat. A supporting rod has a pivot end pivotally connected to the supporting wall unit, and a supporting end opposite to the pivot end. The supporting rod is changeable between an adjustable state, where the supporting rod is rotatable relative to the supporting wall unit about a second axis crossing the first axis, and a non-adjustable state, where the supporting rod is fixed on the supporting wall unit. A rear view mirror body is connected to the supporting rod end.

### BRIEF DESCRIPTION OF THE DRAWINGS

Other features and advantages of the present invention will become apparent in the following detailed description of the preferred embodiment with reference to the accompanying drawings, of which:

FIG. 1 is an exploded perspective view of a rear view mirror disclosed in Taiwanese Patent Publication No. 484560;

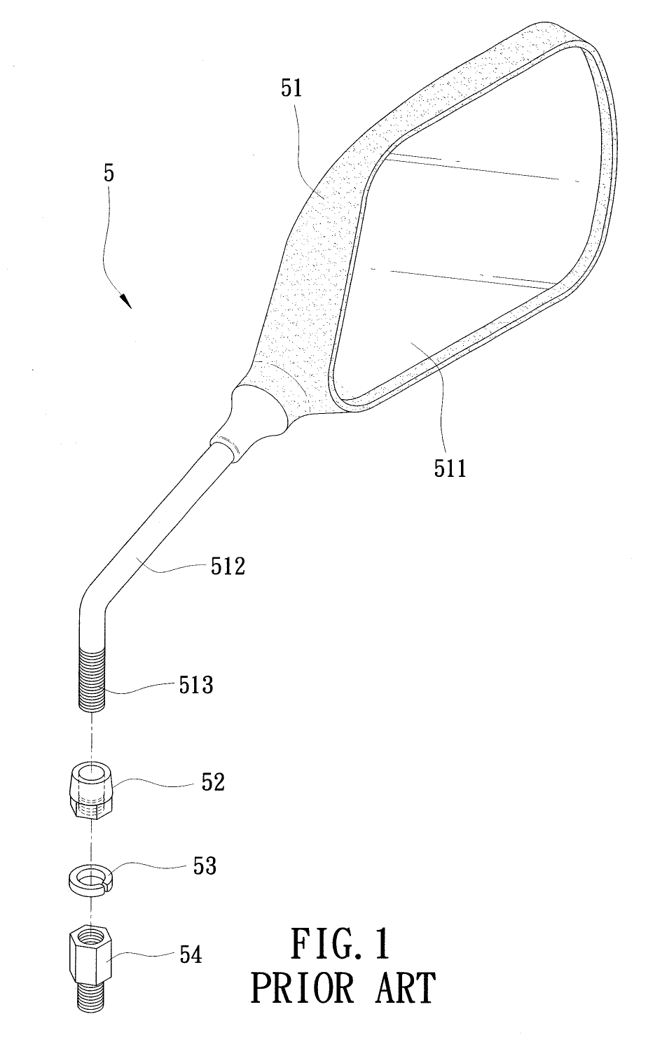

FIG. 2 is an assembled perspective view of the rear view mirror of FIG. 1 mounted on a handle of a motorcycle;

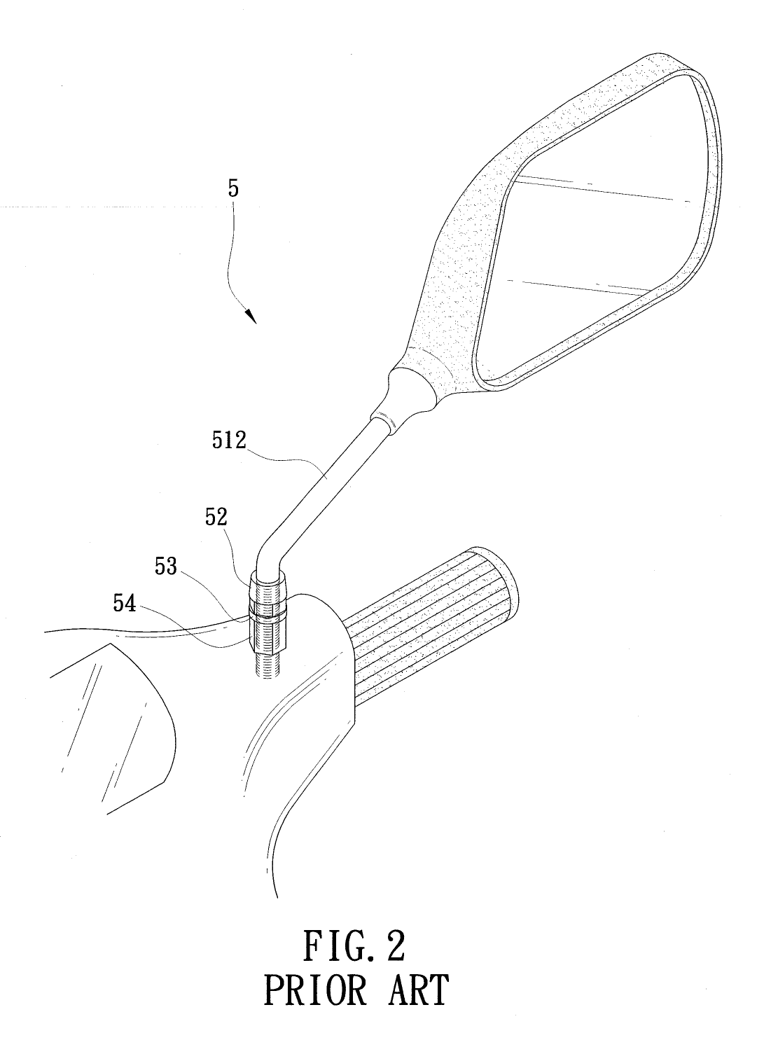

FIG. 3 is a front view of a preferred embodiment of an adjustable rear view mirror according to the present invention;

FIG. 4 is a fragmentary sectional view of the preferred embodiment of the adjustable rear view mirror of FIG. 3;

FIG. 5 is a top view of a mounting seat and a connecting unit of the preferred embodiment;

FIG. 6 is a top view of the preferred embodiment, illustrating how a rotating seat is rotated about a first axis; and

FIG. 7 is a side view of the preferred embodiment, illustrating how a supporting rod is rotated about a second axis.

### DETAILED DESCRIPTION OF THE PREFERRED EMBODIMENT

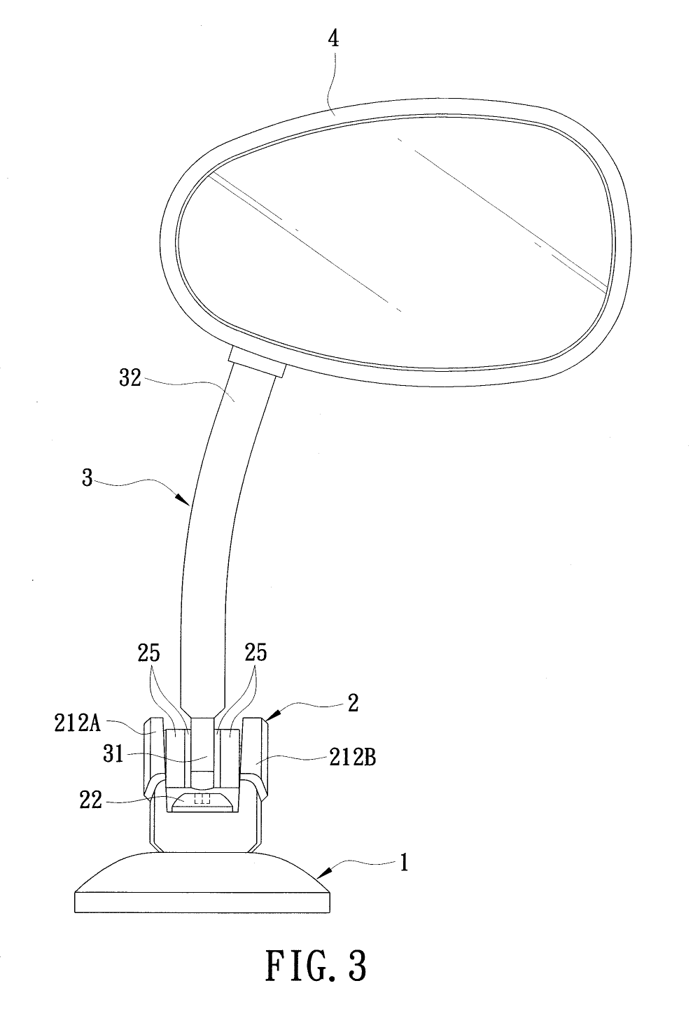

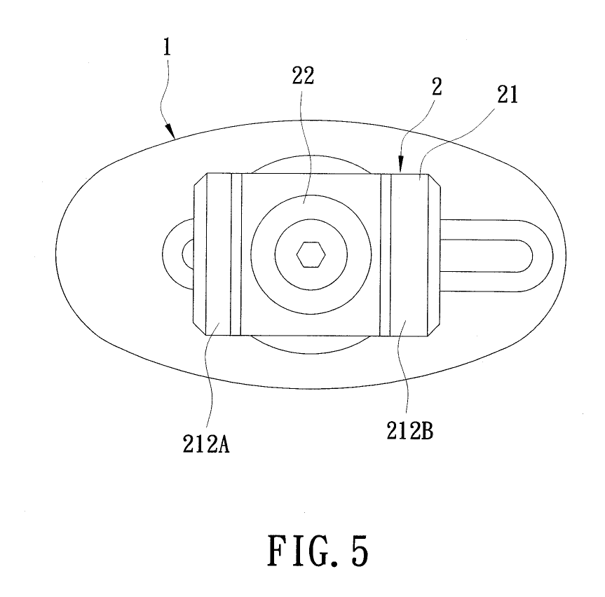

As shown in FIGS. 3 to 5, a preferred embodiment of a rear view mirror according to the present invention comprises a mounting seat 1, a connecting unit 2, a supporting rod 3, and a rear view mirror body 4.

The mounting seat 1 is mounted on a handle of a motorcycle (not shown) and has a screw hole 11.

The connecting unit 2 includes a rotating seat 21, a first adjusting member 22, a plurality of first washers 23, a second adjusting member 24, and a plurality of second washers 25.

The rotating seat 21 has a main body 211 pivotally connected to the mounting seat 1, and a supporting wall unit 212 extending from the main body 211 along a first axis (L1). The first adjusting member 22 includes a stem portion 221 extending through the main body 211 of the rotating seat 21 and into the mounting seat 1 along the first axis (L1). The screw hole 11 of the mounting seat 1 engages the stem portion 221 of the first adjusting member 22. The first adjusting member 22 further includes an abutment portion 222 extending from the stem portion 221 for pressing the main body 211 of the rotating seat 21 against the mounting seat 1.

The first washers 23 are sleeved on the stem portion 221 of the first adjusting member 22. Two of the first washers 23 are clamped between the mounting seat 1 and the main body 211 of the rotating seat 21. The remaining two first washers 23 are clamped between the abutment portion 222 of the first adjusting member 22 and the main body 211 of the rotating seat 21.

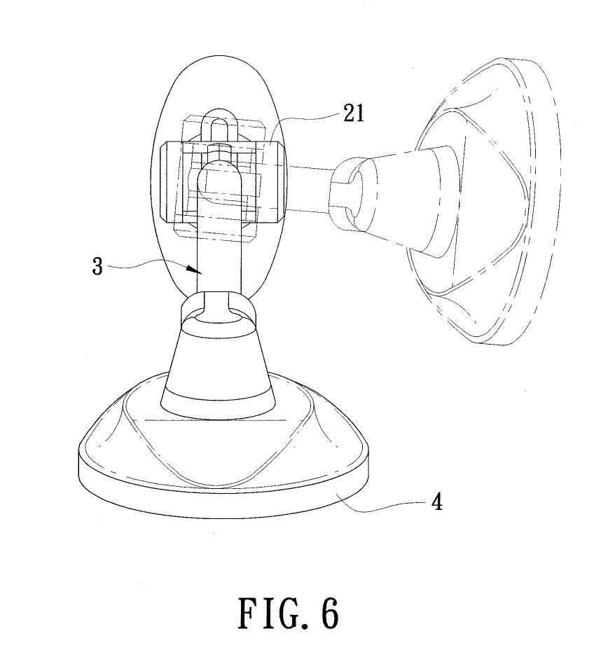

In the preferred embodiment, the first and second adjusting members 22, 24 are configured as screws. The first adjusting member 22 is adjustable to allow change of the rotating seat 21 between a rotatable state (shown in FIG. 6), where the main body 211 is rotatable relative to the mounting seat 1 about the first axis (L1), and a non-rotatable state, where the main body 221 is fixed on the mounting seat 1.

The supporting rod 3 has a pivot end 31 pivotally connected to the supporting wall unit 212, and a supporting end 32 opposite to the pivot end 31. The supporting wall unit 212 has a pair of juxtaposed first and second supporting walls 212A, 212B.

The second adjusting member 24 includes a stem portion 241 extending through the pivot end 31 of the supporting rod 3 and into the second supporting wall 212E along a second axis (L2) crossing the first axis (L1), and an abutment portion 242 extending from the stem portion 241 for pressing the pivot end 31 of the supporting rod 3 against the second supporting wall 212B.

The second supporting wall 212B has a screw hole 213 engaging the stem portion 241 of the second adjusting member 24. The first supporting wall 212A has a hole 214 that is formed therethrough, that is aligned with the screw hole 213 in the second supporting wall 212B, and that permits the abutment portion 242 of the second adjusting member 24 to be received therein.

The second washers 25 are sleeved on the stem portion 241 of the second adjusting member 24. Two of the second washers 25 are clamped between the pivot end 31 of the supporting rod 3 and the second supporting wall 212B. The remaining two second washers 25 are clamped between the abutment portion 242 of the second adjusting member 24 and the pivot end 31 of the supporting rod 3.

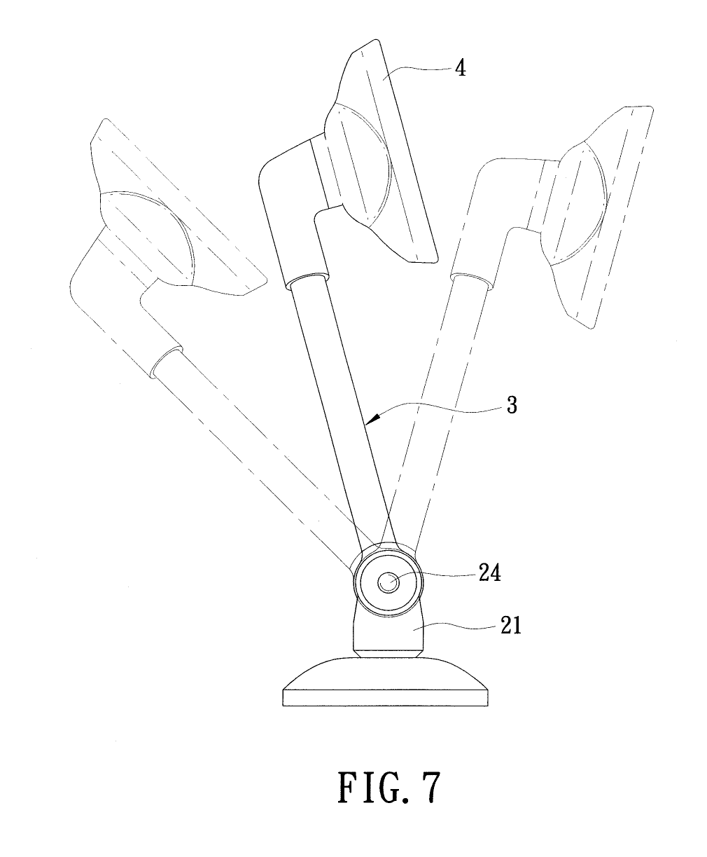

The second adjusting member 24 is adjustable to allow change of the supporting rod 3 between an adjustable state (shown in FIG. 7), where the supporting rod 3 is rotatable relative to the supporting wall unit 212 about the second axis (L2), and a non-adjustable state, where the supporting rod 3 is fixed on the supporting wall unit 212.

The rear view mirror body 4 is connected to the supporting end 32.

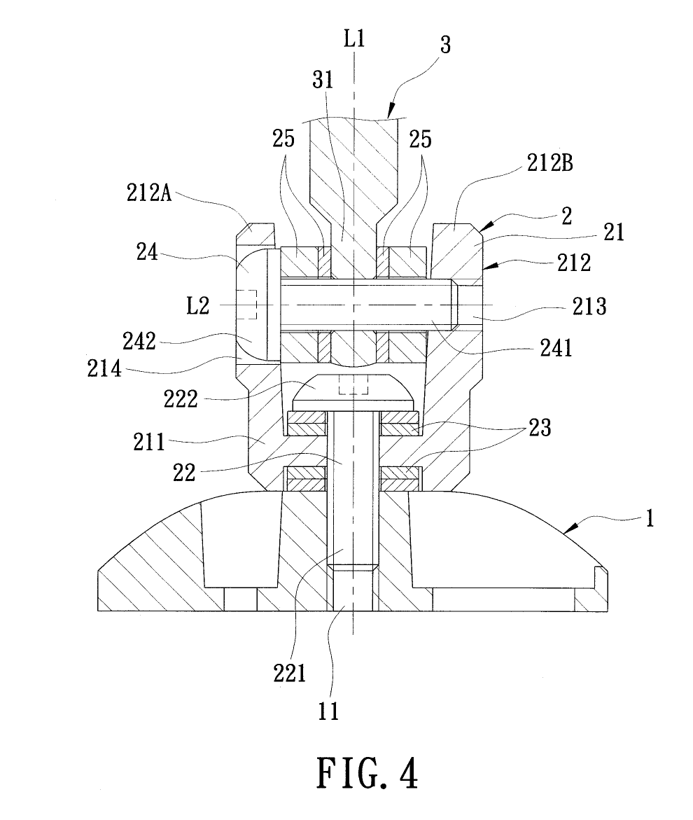

Referring to FIGS. 4, 6, and 7, the adjustment of the rear view mirror body 4 is as illustrated below. When the first and second adjusting members 22, 24 are adjusted to the rotatable and adjustable states, respectively, the rotating seat 21 and the supporting rod 3 are rotated about the first and second axes (L1), (L2), respectively, so as to adjust the rear view mirror body 4 to a desired position. Afterwards, the rotating seat 21 and the supporting rod 3 are adjusted to the non-rotatable and non-adjustable states, respectively, thus fixing the rotating seat 21 and the supporting rod 3 on the supporting wall unit 212 and the mounting seat 1, respectively.

It should be noted that, while this invention is exemplified using the two supporting walls 212A, 212B, only one supporting wall may be provided in other embodiments of this invention, in which the second adjusting member 24 is configured as a screw and a nut that engage each other to allow change of the supporting rod 3 between the adjustable state and the non-adjustable state.

To sum up, the advantages of the adjustable rear view mirror according to the present invention are as outlined in the following. In the present invention, the rotating seat 21 and the supporting rod 3 can be rotated about the first and second axes (L1), (L2), respectively so as to adjust the rear view mirror body 4 to a desired position. In the aforementioned prior art, however, since the slanted supporting rod 512 of the mirror body 51 can only rotate about the supporting rod 513, the mirror surface 511 cannot be adjusted to fit completely users' requirement. Therefore, an adjustable range of the rear view mirror body 4 is broader than that achieved in the aforementioned prior art.

When an external force is applied to strike the rear view mirror body 4, the rotating seat 21 and the supporting rod 3 of the present invention rotate respectively about the first and second axes (L1), (L2), thus preventing the rear view mirror body 4 from damage. Subsequently, the rotating seat 21 and the supporting rod 3 may be rotated back to the original position of the rear view mirror body 4.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. An adjustable rear view mirror, comprising:
a mounting seat;
a connecting unit including a rotating seat, said rotating seat having a main body pivotally connected to said mounting seat, and a supporting wall unit extending from said main body along a first axis, said rotating seat being changeable between a rotatable state, where said main body is rotatable relative to said mounting seat about said first axis, and a non-rotatable state, where said main body is fixed on said mounting seat;
a supporting rod having a pivot end pivotally connected to said supporting wall unit, and a supporting end opposite to said pivot end, said supporting rod being changeable between an adjustable state, where said supporting rod is rotatable relative to said supporting wall unit about a second axis crossing said first axis, and a non-adjustable state, where said supporting rod is fixed on said supporting wall unit; and
a rear view mirror body being connected to said supporting rod end.

2. The adjustable rear view mirror as claimed in claim 1, wherein said connecting unit further includes a first adjusting member extending through said main body of said rotating seat and into said mounting seat along said first axis and adjustable to allow change of said rotating seat between said rotatable state and said non-rotatable state.

3. The adjustable rear view mirror as claimed in claim 2, wherein said first adjusting member has a stem portion extending through said main body of said rotating seat and into said mounting seat, and an abutment portion extending from said stem portion for pressing said main body of said rotating seat against said mounting seat.

4. The adjustable rear view mirror as claimed in claim 3, wherein said mounting seat has a screw hole engaging said stem portion of said first adjusting member, and said first adjusting member is configured as a screw.

5. The adjustable rear view mirror as claimed in claim 4, wherein said connecting unit further includes a plurality of first washers sleeved on said stem portion of said first adjusting member, at least one of said first washers being clamped between said mounting seat and said main body of said rotating seat, the remaining of said first washers being clamped between said abutment portion of said first adjusting member and said main body of said rotating seat.

6. The adjustable rear view mirror as claimed in claim 1, wherein said connecting unit further includes a second adjusting member extending along said second axis and adjustable to allow change of said supporting rod between said adjustable state and said non-adjustable state.

7. The adjustable rear view mirror as claimed in claim 6, wherein said supporting wall unit of said rotating seat has a pair of juxtaposed first and second supporting walls, said second adjusting member extending through said first supporting wall and said pivot end of said supporting rod and into said second supporting wall.

8. The adjustable rear view mirror as claimed in claim 7, wherein said second adjusting member has a stem portion extending through said pivot end of said supporting rod and into said second supporting wall, and an abutment portion extending from said stem portion for pressing said pivot end of said supporting rod against said second supporting wall.

9. The adjustable rear view mirror as claimed in claim 8, wherein said second adjusting member is configured as a screw, said second supporting wall having a screw hole engaging said stem portion of said second adjusting member, said first supporting wall having a hole that is formed therethrough, that is aligned with said screw hole in said second supporting wall, and that permits said abutment portion of said second adjusting member to be received therein.

10. The adjustable rear view mirror as claimed in claim 9, wherein said connecting unit further includes a plurality of second washers sleeved on said stem portion of said second adjusting member, at least one of said second washers being clamped between said pivot end of said supporting rod and said second supporting wall, the remaining of said second washers being clamped between said abutment portion of said second adjusting member and said pivot end of said supporting rod.
